(19) United States
(12) Patent Application Publication
(10) Pub. No.: US 2026/0259105 A1
(43) Pub. Date: Sep. 3, 2026

(54) OPTICAL TIME DOMAIN REFLECTOMETRY FOR HOLLOW CORE OPTICAL FIBRES

(71) Applicant: University of Southampton, Southamptom Hampshire (GB)

(72) Inventors: Radan SLAVIK, Southampton, Hampshire (GB); David John RICHARDSON, Southampton, Hampshire (GB); Francesco POLETTI, Southampton, Hampshire (GB); Thomas David BRADLEY, Southampton, Hampshire (GB); Austin TARANTA, Southampton, Hampshire (GB); Eric NUMKAM-FOKOUA, Southampton, Hampshire (GB)

(73) Assignee: University of Southampton, Southamptom Hampshire (GB)

(21) Appl. No.: 18/837,230

(22) PCT Filed: Feb. 2, 2023
(86) PCT No.: PCT/GB2023/050231

§ 371 Date: Aug. 9, 2024

(30) Foreign Application Priority Data
Feb. 11, 2022 (GB) 2201785.9

(51) Int. Cl. G01M 11/00

(52) U.S. Cl. CPC G01M 11/3109

(57) ABSTRACT

A method of assessing an optical system comprising a hollow core optical fibre comprises providing an optical time domain reflectometry system comprising: an optical source configured to generate optical pulses with wavelength λ; an optical detector configured to detect light at wavelength λ; and an input/output fibre comprising a solid core optical fibre optically coupled at a proximal end to receive optical pulses from the optical source and deliver light to the optical detector, and having at its distal end an end facet with an applied treatment configured to suppress back-reflection of light at wavelength λ caused at an interface of glass forming the core of the solid core optical fibre and air at the end facet.

### BACKGROUND OF THE INVENTION

The present invention relates to methods and systems for performing optical time domain reflectometry with hollow core optical fibres.

Optical time domain reflectometry (OTDR) is a well-established technique for spatially resolving and measuring continuous and localised parameters of optical fibres. It is routinely used for measurements on fabricated fibres, fibre cables and installed optical fibre systems such as telecommunications links and networks.

OTDR is performed by launching pulses of light into an end of a length of optical fibre. As a pulse propagates along the fibre it undergoes scattering from the material forming the fibre, some of which is backscattered towards the launch end where it can be detected. The use of discrete pulses of known duration coupled with the known propagation speed of light along the fibre allows the spatial origin of the detected light with respect to distance along the fibre to be determined, yielding a profile of reflected light level or power over the fibre length. Particular characteristics and circumstances within the fibre or externally thereto will modify the amount of backscatter and the originating location of the scattering can be pinpointed with a spatial resolution that depends on the pulse length. This allows fibre characteristics such as localised defects and changes in structure to be identified, as well as the detection of external parameters that modify fibre properties such as temperature and pressure. Hence a fibre can be tested or characterised, or used as a distributed sensor. In installed optical fibre systems comprising multiple fibre segments, joints such as splices and connectors between different segments can be identified and characterised, and faults such as fibre breaks can be located.

In order for backscattering to be used in this way, it is crucial that the optical fibre can produce backscatter for detection. In particular, OTDR detects Rayleigh scattering, which is elastic scattering of the launched light pulses from the fibre material. Rayleigh scattering is caused by microscopic density fluctuations in the fibre which are due to the amorphous structure of glass from which optical fibre is formed. Hence, OTDR is a proven and useful technique for assessing solid core optical fibre (SCF). SCF comprises a longitudinal core of a first refractive index surrounded by a cladding of a lower refractive index, both the core and the cladding comprising glass. Propagating light is guided along the fibre by total internal reflection at the refractive index boundary.

A problem arises for other types of optical fibre, however. A class of optical fibres having a hollow core, that is, a core defined by a longitudinal void, surrounded by a cladding formed by a plurality of longitudinal capillaries with glass boundaries arranged in a defined structure, is becoming well-developed. Light is guided via different mechanisms than the total internal reflection in a SCF. These fibres, which can be referred to as hollow core fibres (HCF), can demonstrate an advantageously low optical propagation loss, owing to the absence of glass from the core, which causes absorption and attenuation in a SCF. Hence, HCFs are of great interest for many applications, including telecommunications and remote sensing, and have been shown to be capable of transmitting data over thousands of kilometres. However, the absence of a glass core, which gives HCFs their attractive low loss characteristics, also removes most of the density fluctuations that produce Rayleigh scattering, making detailed OTDR apparently unfeasible with HCFs. Trivial measurements can be obtained, including the measurement of fibre length since large reflections from the glass boundaries at the proximal and distal ends of a fibre can be detected, but only information about the grossest defects can be extracted from the reflected light [1].

Alternative methods have been proposed for distributed measurements and characterisation of HCFs. An example is optical side scattering radiometry [2] which has been reported in an 11 km length of hollow core fibre of a type known as photonic bandgap hollow core fibre, the authors noting that “the characterisation requirements of which lie far beyond the capability of standard optical reflectometric instruments.”

A further example is given in U.S. Pat. No. 10,845,268 [3], which proposes to alternate lengths of HCF and SCF and obtain backscattering via OTDR from the SCF sections. This enables only localised characterisation of the fibre, at the SCF locations, and the introduction of SCF negates the benefits of HCF such as low loss, low latency, high power handling and low nonlinearity.

Accordingly, approaches that enable genuine OTDR of HCF are of interest.

### SUMMARY OF THE INVENTION

Aspects and embodiments are set out in the appended claims.

According to a first aspect of certain embodiments described herein, there is provided a method of assessing an optical system comprising a hollow core optical fibre, comprising providing an optical time domain reflectometry system comprising: an optical source configured to generate optical pulses with wavelength λ; an optical detector configured to detect light at wavelength λ; and an input/output fibre comprising a solid core optical fibre optically coupled at a proximal end to receive optical pulses from the optical source and deliver light to the optical detector, and having at its distal end an end facet with an applied treatment configured to suppress back-reflection of light at wavelength λ caused at an interface of glass forming the core of the solid core optical fibre and air at the end facet; aligning the distal end of the input/output fibre with a proximal end of a hollow core optical fibre having gas present in the hollow core, for optical transmission between the input/output fibre and the hollow core optical fibre; operating the optical source to generate optical pulses for propagation along the input/output fibre and into the hollow core fibre; receiving backscattered light produced by Rayleigh scattering of the optical pulses from the gas in the hollow core of the hollow core fibre and detecting the backscattered light with the optical detector to generate a detected signal; and processing the detected signal to create an optical time domain reflectometry profile comprising a distribution of backscattered optical power along a length of the hollow core optical fibre.

According to a second aspect of certain embodiments described herein, there is provided an optical time domain reflectometry system comprising: an optical source configured to generate optical pulses with wavelength λ; an optical detector configured to detect light at wavelength λ; an input/output fibre comprising a solid core optical fibre optically coupled at a proximal end to receive optical pulses from the optical source and deliver light to the optical detector, and having at its distal end an end facet with an applied treatment configured to suppress back-reflection of light at wavelength λ caused at an interface of glass forming the core of the solid core optical fibre and air at the end facet; an alignment apparatus for aligning the distal end of the input/output fibre with a proximal end of a hollow core optical fibre having gas present in the hollow core, for optical transmission between the input/output fibre and the hollow core optical fibre; and a processor to receive a detected signal generated by the optical detector from received backscattered light produced by Rayleigh scattering of optical pulses from the optical source in the gas in the hollow core of the hollow core optical fibre, and process the detected signal to create an optical time domain reflectometry profile comprising a distribution of backscattered optical power along a length of the hollow core optical fibre.

These and further aspects of certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, methods and systems may be provided in accordance with approaches described herein which includes any one or more of the various features described below as appropriate.

### BRIEF DESCRIPTION OF THE DRAWINGS

For a better understanding of the invention and to show how the same may be carried into effect reference is now made by way of example to the accompanying drawings in which:

FIG. 1 shows a transverse cross-sectional view of an example of a photonic bandgap hollow core optical fibre, to which aspects of the invention are applicable;

FIG. 2 shows a transverse cross-sectional view of a first example antiresonant hollow core optical fibre, to which aspects of the invention are applicable;

FIG. 3 shows a transverse cross-sectional view of a second example antiresonant hollow core optical fibre, to which aspects of the invention are applicable;

FIG. 4 shows a graph of results of a simulation of components of backscatter in an antiresonant hollow core fibre as a function of wavelength;

FIG. 5 shows a graph of results of a simulation of components of backscatter in an antiresonant hollow core fibre as a function of core diameter of the fibre;

FIG. 6 shows an optical time domain reflectometry profile of backscattered power distributed over fibre distance experimentally obtained from a first sample of antiresonant hollow core fibre;

FIG. 7 shows optical time domain reflectometry profiles of backscattered power distributed over fibre distance experimentally obtained from the first sample of antiresonant hollow core fibre, for different optical pulse widths or durations;

FIG. 8 shows the optical time domain reflectometry profile of FIG. 6 normalised for fibre length.

FIG. 9 shows an optical time domain reflectometry profile of backscattered power distributed over fibre distance experimentally obtained from a second sample of antiresonant hollow core fibre;

FIG. 10 shows optical time domain reflectometry profiles of backscattered power distributed over fibre distance experimentally obtained from the second sample of antiresonant hollow core fibre, for different optical pulse widths or durations;

FIG. 11 shows a schematic representation of an optical time domain reflectometry system according to an example of the invention;

FIG. 12 shows a simplified longitudinal cross-sectional view of an input/output fibre of an optical time domain reflectometry system with a distal end treatment for reduced back reflection according to a first example;

FIG. 13 shows a simplified longitudinal cross-sectional view of an input/output fibre of an optical time domain reflectometry system with a distal end treatment for reduced back reflection according to a second example;

FIG. 14 shows a simplified longitudinal cross-sectional view of an input/output fibre of an optical time domain reflectometry system with an example distal end treatment for low coupling loss;

FIG. 15 shows a schematic representation of an example alignment apparatus for an optical time domain reflectometry system according to an embodiment; and

FIG. 16 shows a flow chart of an example method according to an embodiment.

### DETAILED DESCRIPTION

Aspects and features of certain examples and embodiments are discussed / described herein. Some aspects and features of certain examples and embodiments may be implemented conventionally and these are not discussed/described in detail in the interests of brevity. It will thus be appreciated that aspects and features of systems and methods discussed herein which are not described in detail may be implemented in accordance with any conventional techniques for implementing such aspects and features.

Hollow core optical fibres (HCFs) have a structure comprising an array or arrangement of holes, capillaries or lumen within the fibre material, extending along the length of the fibre parallel to the longitudinal axis and defined within a material such as glass. The arrangement of holes can be termed a microstructure, and typically the microstructure forms at least part of the cladding of the fibre, and surrounds a central hollow void or region that provides a light-guiding core, and which may be filled with air or another gas. The capillaries of the microstructure are typically supported within a larger outer cladding tube made from glass. The propagation of light in air enabled by the absence of a solid glass core reduces the proportion of a guided optical wave which propagates in glass compared to a solid core fibre, offering benefits such as increased propagation speed, reduced loss from both absorption and scattering, and reduced nonlinear interactions. Hence hollow core fibres are very attractive for applications including telecommunications; they enable data transmission at nearly the speed of light in vacuum, and at higher optical powers and over broader optical bandwidths, with relative freedom from issues such as nonlinear and thermo-optic effects that can affect light travelling in solid fibres.

Hollow core fibres can be categorised according to their mechanism of optical guidance into two principal classes or types: hollow core photonic bandgap fibre (HCPBF, alternatively referred to as hollow core photonic crystal fibre, HCPCF) [4], and antiresonant hollow core fibre (AR-HCF or ARF) [5], of which there are various subcategories characterised by the geometric structure of the cladding capillaries. The present disclosure is applicable to all types of hollow core fibre, including these two main classes and their associated sub-types plus other hollow core designs. Note that in the art, there is some overlapping use of terminologies for the various classes of fibre. For the purposes of the present disclosure, the terms “hollow core fibre” and “hollow core microstructured fibre” are intended to cover all types of these fibres having a hollow core as described above. The terms “HCPBF” and “HCPCF” are used to refer to hollow core fibres which have a structure that provides waveguiding by photonic bandgap effects (described in more detail below). The terms “ARF” and “antiresonant hollow core fibre” are used to refer to hollow core fibres which have a structure that provides waveguiding by antiresonant effects (also described in more detail below).

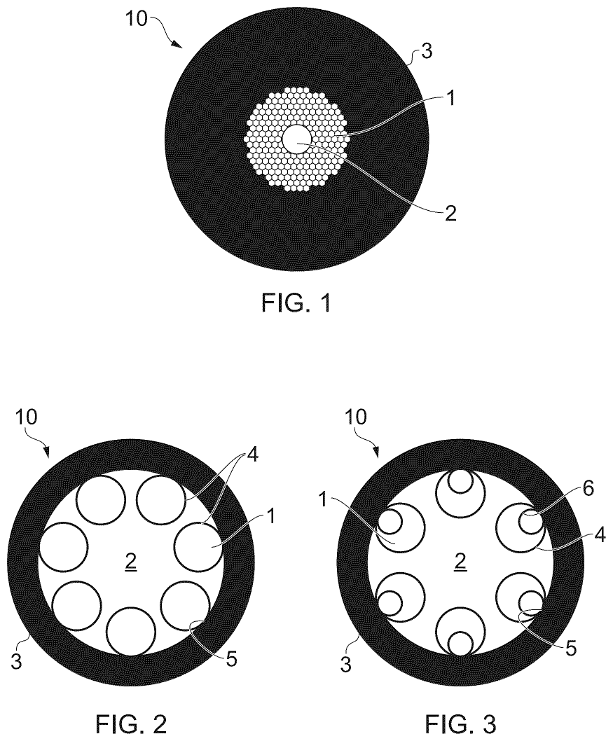

FIG. 1 shows a cross-sectional view of an example HCPBF 10. In this fibre type, a structured, inner, cladding 1 comprises a regular closely packed array of many small glass capillaries, from which a central group is excluded to define a substantially circular hollow core 2. The cladding capillaries are arranged in multiple rings around the core 2. The periodicity of the cladding structure 1 provides a substantially periodically structured refractive index and hence a photonic bandgap effect that confines the propagating optical wave towards the core 2. These fibres can be described in terms of the number of cladding capillaries or “cells” which are excluded to make the core 2. In the FIG. 1 example, the central nineteen cells from the array are absent in the core region, making this a 19-cell core HCPBF. The structured cladding 1 is formed from six rings of cells surrounding the core 2, plus some cells in a seventh ring to improve the circularity of the outer surface of the structured cladding 1. In other examples, different numbers of rings may be used to define the cladding 1. An outer cladding 3 surrounds the structured cladding 1; this is a tube that supports the capillaries of the structured cladding 1.

In contrast to HCPBF, antiresonant hollow core fibres guide light by an antiresonant optical guidance effect. The structured cladding of ARFs has a simpler configuration, comprising a much lower number of larger glass capillaries or tubes than a HCPBF to give a structure lacking a high degree of periodicity so that photonic bandgap effects are not significant, but with some rotational periodicity on a larger scale since the tubes are evenly disposed (with or without spaces). The cladding capillaries comprise only a single ring of capillaries around the core; additional smaller capillaries may be included inside the capillaries of the primary single ring. The structure means that antiresonance is provided for propagating wavelengths which are not resonant with a wall thickness of the cladding capillaries, in other words, for wavelengths in an antiresonance window which is defined by the cladding capillary wall thickness. The cladding capillaries surround a central void or cavity which provides the hollow core of the fibre, and which is able to support antiresonantly-guided optical modes. The structured cladding can also support cladding modes able to propagate primarily inside the capillaries, in the glass of the capillary walls or in the spaces or interstices between the cladding capillaries and the fibre's outer cladding. The loss of these additional non-core guided modes is generally very much higher than that of the core guided modes. The fundamental core guided mode typically has by far the lowest loss amongst the core guided modes. The antiresonance provided by a capillary wall thickness which is in antiresonance with the wavelength of the propagating light acts to inhibit coupling between the fundamental core mode and any cladding modes, so that light is confined to the core and can propagate at very low loss.

FIG. 2 shows a transverse cross-sectional view of an example simple antiresonant hollow core fibre. The fibre 10 has an outer tubular cladding 3. The structured, inner, cladding 1 comprises a plurality of tubular cladding capillaries 4, in this example seven capillaries of the same cross-sectional size and shape, which are arranged inside the outer cladding 3 in a single ring, so that the longitudinal axes of each cladding capillary 4 and of the outer cladding 3 are substantially parallel. Each cladding capillary 4 is in contact with (bonded to) the inner surface of the outer cladding 3 at a location 5, such that the cladding capillaries 4 are evenly spaced around the inner circumference of the outer cladding 3, and are also spaced apart from each other so there is no contact between neighbouring capillaries. In some designs of ARF, the cladding tubes 4 may be positioned in contact with each other (in other words, not spaced apart as in FIG. 2), but spacing to eliminate this contact can improve the fibre's optical performance. The spacing removes nodes that arise at the contact points between adjacent tubes and which tend to cause undesirable resonances that result in high losses. Accordingly, fibres with spaced-apart cladding capillaries may be referred to as “nodeless antiresonant hollow core fibres”.

The arrangement of the cladding capillaries 4 in a ring around the inside of the tubular outer cladding 3 creates a central space, cavity or void within the fibre 10, also with its longitudinal axis parallel to those of the outer cladding 3 and the capillaries 4, which is the fibre's hollow core 2. The core 2 is bounded by the inwardly facing parts of the outer surfaces of the cladding capillaries 4. This is the core boundary, and the material (glass or polymer, for example) of the capillary walls that make up this boundary provides the required antiresonance optical guidance effect or mechanism. The capillaries 4 have a thickness at the core boundary which defines the wavelength for which antiresonant optical guiding occurs in the ARF.

FIG. 3 shows a transverse cross-sectional view of a second example ARF. The ARF 10 has a structured inner cladding 1 comprising six cladding capillaries 4 evenly spaced apart around the inner surface of a tubular outer cladding 3 and forming a single, primary ring surrounding a hollow core 2. Each cladding capillary 4 has a secondary, smaller capillary 6 nested inside it, bonded to the inner surface of the cladding capillary 4, in this example at the same azimuthal location 5 as the point of bonding between the primary capillary 4 and the outer cladding 3. These additional smaller capillaries 6 can reduce the optical loss. Additional still smaller tertiary capillaries may be nested inside the secondary capillaries 6. ARF designs of this type, with secondary and optionally smaller further capillaries, may be referred to as “nested antiresonant nodeless fibres”, or NANFs [6]. In other NANF designs, one or more additional secondary capillaries may be nested within a primary capillary. Many other capillary configurations for the structured cladding of an ARF are possible, and the disclosure is not limited to the examples described above. For example, the capillaries need not be of circular cross-section, and/or may or may not be all of the same size and/or shape. The number of capillaries surrounding the core in the primary ring may be for example, four, five, six, seven, eight, nine, ten or more.

Hollow core optical fibres may be made from any of the glass-based materials known for the fabrication of solid core fibres, in particular silica. Types of glass include “silicate glasses” or “silica-based glasses”, based on the chemical compound silica (silicon dioxide, or quartz), of which there are many examples. Other glasses suitable for optical fibres include, but are not limited to, doped silica glasses. The materials may include one or more dopants for the purpose of tailoring the optical properties of a fibre, such as modifying absorption or transmission, or tailoring properties of the materials for purposes such as facilitating fibre manufacture, improving reliability, or enabling or enhancing a particular end use. Fibres may also be made from polymer materials.

Herein, terms including hollow core optical fibre, hollow core fibre, hollow core waveguide, hollow core optical waveguide, hollow core microstructured fibre, hollow core microstructured waveguide, and similar terms are intended to cover optical waveguiding structures configured according to any of the above examples and similar structures, where light is guided by any of several guidance mechanisms (photonic bandgap guiding, antiresonance guiding, and/or inhibited coupling guiding) in a hollow elongate void or core surrounded by a structured (microstructured) cladding comprising a plurality of longitudinal capillaries. These various terms may be used interchangeably in the present disclosure.

For all hollow core fibres, a common characteristic is the absence of a glass core, and therefore also the absence of microscopic glass density fluctuations to create Rayleigh scattering which is conventionally detected in optical time domain reflectometry. HCFs are now highly developed and viable, however, being manufacturable in multi-kilometre lengths with very low loss or attenuation levels (0.22 dB/km having been reported), and capable of transmitting data over thousands of kilometres (proven in recirculating loop experiments), and also beginning to be cabled and installed in ducts to carry live data traffic. To drive further manufacturing improvements, and to enable testing of HCF cables in the laboratory and in the field, it would be useful to be able to employ established distributed characterisation techniques to identify fibre faults, manufacturing imperfections, or irregularities along the fibre length. These functions are carried out using OTDR for solid core fibre systems, but conventional understanding suggests that this cannot usefully be applied to HCF owing to the very low level of backscattering.

The Rayleigh backscattering detected in OTDR is a weak optical effect. Current conventional solid core optical fibres formed from silica glass (such as standard single-mode fibre, SMF) can typically produce a backscattered signal from a one metre length of fibre which is around 72 dB below the launched power (backscattering coefficient of −72 dB/m). In commercially available OTDR instruments, this level of backscattering is compatible with the routine characterisation of fibres with lengths up to about 160-400 km (e.g., using the FTB7600 model from EXFO, Canada or LOR-200 model from Luciol, Switzerland). In contrast, the lowest loss data transmitting HCFs reported to date, which are a NANF design [7], have much lower levels of backscattering from the glass surfaces within the fibre structure, reported to be as low as −118 dB/m, over 45 dB lower than the backscattered signal in a typical SMF. A custom-built OTDR reflectometer was required to make this measurement, capable of measuring backscattered signals as weak as −140 dB/m with a spatial resolution better than 1 m [8]. No such equipment is commercially available however, so widespread testing and assessment of HCF, particularly in the field, is not currently possible.

The present disclosure, however, proposes approaches for adapting optical time domain reflectometry for application to hollow core optical fibres.

Backscattering from antiresonant hollow core fibre (ARF) has been studied [9]. Three backscattering contributors were analysed. To compare the (relative) magnitudes of these, calculated values given at 1550 nm for a fibre with a core diameter of 35 μm are considered here. The Rayleigh backscattering from the bulk glass in the microstructure (that is, forming the cladding capillaries) was found to be very low (−150 dB/m), which is understandable given the very small fraction of the guided light propagating through the glass (less than 0.01% of the light energy). The other two contributors are identified as backscattering caused by the surface roughness of the glass microstructure surfaces (−115 dB/m) and Rayleigh backscattering from gases that may fill the HCF's hollow regions (−100 dB/m for air at atmospheric pressure). These low levels of backscatter are beyond the detection capability of standard OTDR apparatus. Consideration of other known reflectometric techniques may suggest the use of a phase-sensitive measurement technique such as optical frequency domain reflectometry (OFDR) or phase-OTDR to measure such low levels of backscattering. However, when using these techniques, the thermal motion of gas molecules at room temperature must be considered. This causes Doppler broadening of the received light signal, which ‘blurs’ the useful signal. As a result, the signal backscattered from the gas may not be detected, and only the weaker signal scattered from the static scatterers on the glass surfaces is measured. Information carried by scattering from the gas is lost.

The present disclosure is based on the recognition that, contrary to general understanding, the low level of backscatter from gas in the voids of a HCF can in fact be usefully detected with typical, non-custom built OTDR equipment. To measure backscattering from inside HCFs, the use of a high sensitivity OTDR is proposed, standard implementations of which are not phase-sensitive and are thus insensitive to Doppler broadening in the moving gas. As described above, Rayleigh backscattering from the gas (typically air) inside an antiresonant HCF has been predicted to be stronger than surface scattering by about 15 dB), and the present inventors estimated that the sensitivity of a current top-of-the-range OTDR would be sufficient for its detection. From the fibre characterisation point of view, this represents using a less sensitive method (OTDR rather than OFDR) to measure a stronger signal (air scattering rather than surface scattering), resulting in a low or no overall loss of the signal-to-noise ratio. It also enables the use of commercially-available instrumentation. An additional advantage is the polarization insensitivity of most OTDRs as compared to phase-sensitive methods, directly providing a measurement of the total scattered power, which is the information of interest in routine fibre characterization and testing.

Considering the amount of backscattering predicted to be available from a gas-filled HCF, the inventors propose that successful OTDR measurements of HCFs can be achieved by careful handling of the coupling loss of the light pulses coupled into the HCF (where necessary, in order to maximise the amount of available light launched into the HCF), and of the strong back-reflections that happen at the glass-air interface between the portion of SMF by which light is coupled out of and into the OTDR device or apparatus, and the input facet of the HCF under test. Since commercially available OTDR devices are designed for use with solid core fibres (SCF), the output/input fibre which forms part of the device for connection with the fibre under test is a portion of solid core fibre, typically SMF. As is well known, a 4% reflection of light occurs at a glass-air interface, and such an interface is created if a HCF is coupled to the SCF input/output of an OTDR device, since the hollow core of the HCF is air- or gas-filled. Without an efficient suppression of this 4% reflection, which would otherwise be directed back into the OTDR device, the OTDR measurement is limited by saturation due to the strong initial reflection peak from the interface, rather than by the sensitivity of the instrument, and the backscatter is liable to be undetectable. Hence, in order to access the full sensitivity of an OTDR device so that the low level of backscatter from gas in a HCF can be measured, it is proposed that this back-reflection is removed or reduced.

Simulations (computer modelling) of the back scattering contributions identified as occurring in HCF have been carried out in order to support the concept of OTDR based on Rayleigh scattering from air or gas in HCF. More detailed simulations of backscattering in antiresonant HCFs have been presented elsewhere [9], showing that the overall backscattering coefficient depends mainly on the radius R of the fibre's core and the wavelength λ of the propagating pulses, and is relatively insensitive to the antiresonant HCF microstructure. The backscattered contribution due to surface scattering was found to scale with λ³/R⁶, while the contribution from the gas inside the hollow core follows 1/(λR)².

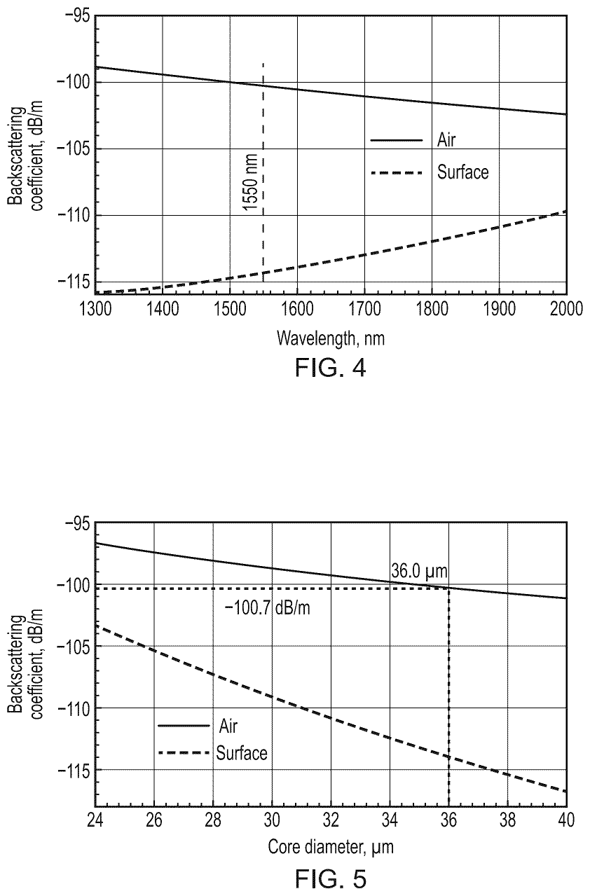

FIG. 4 shows a graph of the variation of backscatter coefficient with wavelength as determined by the simulation, for both air and the glass surfaces in the fibre. The fibre used in the simulation was a NANF-type hollow core fibre (similar to fibres used in experiments which are described later) and assumed to be filled with air at atmospheric pressure. Note that actual manufactured fibres may have pressure or gas composition different from this but the invention is not limited in this way and is applicable to HCFs with gas-filled cores in general, where the gas may be air or a particular gas or gas composition, where either may be present from the fibre fabrication process or added later. The fibre core diameter was fixed at 36 μm. The backscatter from air is shown as a solid line and the backscatter from glass surfaces is shown as a dashed line. As can be seen, the Rayleigh backscattering from the atmospheric air inside the fibre is well above the predicted surface scattering for all modelled wavelengths, 1300 nm-2000 nm. The expected decrease of both with increasing wavelength is observed.

FIG. 5 shows a graph of the variation of backscatter coefficient with core diameter as determined by the simulation, for both air (solid line) and the glass surfaces (dashed line) in the fibre. The fibre had the same NANF design as for the FIG. 4 simulation, again filled with atmospheric air, but with the core diameter varied from 24 μm to 40 μm, and the wavelength of the OTDR pulses being fixed at 1550 nm. Again, the Rayleigh backscattering from the atmospheric air inside the fibre is well above the predicted surface scattering for all core diameters. The expected decrease of both with increasing core diameter is observed.

This identification of a level of Rayleigh backscatter from the air or gas in a hollow core fibre which is within the detection capability of known OTDR technology is a surprising result, and unexpected from previously reported observations, and enables the proposed OTDR methods disclosed herein when combined with certain apparatus adaptations described below. The proposed methods can be utilised for the assessment (testing, analysis, investigation) of optical systems and optical fibre systems that comprise or include hollow core optical fibre, either alone or in combination with other optical fibre types and waveguiding components.

From these simulations, it can be concluded that scattering from air is substantially more significant across a wide spectral range and for all practical ranges of core diameters. The simulations suggest an air-dominated Rayleigh backscattering at a level of −100 dB/m at 1550 nm and for a core diameter of 36 μm. In terms of the change in backscattering level with core diameter, FIG. 5 shows that for a ±1 μm deviation in core diameter about 36 μm, the backscattering coefficient is expected to change by ±0.35 dB. Accordingly, an OTDR device configured to increase or maximise detection of the air-originating Rayleigh backscatter from a HCF is proposed. Steps are taken in order to enhance the signal-to-noise ratio and dynamic range, by reducing or suppressing the 4% reflection at the glass-air interface where the HCF is coupled to a SCG for optical communication with the OTDR device, and enabling low loss coupling between the SCF and the HCF.

Experiments have been performed to demonstrate the OTDR results which can be achieved following this approach. A commercially-available OTDR based on sensitive photon-counting detection (LOR-200 from Luciol, Switzerland), was used; this provides a state-of-the-art dynamic range for optical pulses of 1 μs duration (corresponding to a spatial resolution in HCF of ~300 m). Pulses of around 10 mW peak power are generated, although higher pulse powers can be used for the proposed OTDR methods and can give better results, in addition to being tolerated by HCF which have a much lower optical nonlinearity than SCF. NANF-design HCF were tested. In particular, long lengths of fibre, in excess of 4 km, were investigated, since this enabled the use of longer pulses, which give a lower spatial resolution to the OTDR distributed profile but offer a better signal-to-noise ratio owing to the greater total power per pulse. Note that commercial OTDR devices typically allow pulse duration to be changed, while the peak pulse power remains the same so that longer pulses have a larger total power. A low back reflection approach and a low loss coupling approach were used to join the SCF and the HCF, which are described further below. In order to match the simulations, HCF with core diameters near 36 μm were used, with a pulse wavelength of 1550 nm. As will be seen, the experiments yielded from the measurement data an estimated backscattering coefficient of −102 dB/m, which is very close to the predicted value of −100 dB/m mentioned above. The ability to identify isolated scattering events along a fibre, such as may be caused by isolated fibre imperfections, were demonstrated to be identifiable down to a spatial resolution of 10 m.

The OTDR device used in the experiments is a field-deployable device which uses sensitive photon counting photodetectors, offering sufficient sensitivity that backscattering from a NANF HCF filled with air at atmospheric pressure was expected to be measurable. The OTDR is designed to have a backscattering dynamic range of 57 dB for an SMF at 1550 nm (60 dB at 1.3 μm) when the longest (1 μs) pulses are used. Consequently, with 1 μs pulses (corresponding to 300 m spatial resolution in HCF) one would expect to measure backscattered signals from a NANF filled with atmospheric pressure air that are 27 dB above the noise floor (about 30 dB lower than for SMF). Measurements at 10 times better resolution (30 m) should generate signals up to 17 dB above the noise floor, since the shorter pulses required for higher resolution comprise less power and hence a lower signal-to-noise ratio.

A further limiting factor in an OTDR measurement is the maximum difference between the strongest and weakest signals that can be measured, which is typically 30-50 dB, depending on the OTDR instrument and the measurement settings. When measuring HCF, it is therefore appropriate to carefully manage the 4% reflection that typically happens at the air-glass boundary between the OTDR input/output SMF and the HCF, since this corresponds to −14 dB, a large fraction of the available measurement range. For a 1 μs pulse, the back-reflection peak at −14 dB is 35 dB above the SMF backscattering level (−49 dB) and 65 dB above the expected backscattering level in the NANF HCF (−79 dB), thereby preventing measurement of the NANF backscattering level. To suppress this back-reflection, an angle-polished solid core fibre was used to couple to the HCF, in other words a fibre having an end facet cleaved or polished at a non-orthogonal angle to the optical axis of the fibre. This suppressed back-reflection at the input to the OTDR to below −60 dB. To further reduce the insertion loss (by 0.15 dB), a simple four-layer anti-reflective (AR) coating was applied to the angled SCF. An angle-cleaved fibre with −49 dB back-reflection without any AR coating was also used and found to be sufficient for the collection of backscattering data. The angled facet and/or the AR coating provide a low-reflection interface with the HCF, intended to minimise the amount of optical pulse power reflected back into the OTDR device to avoid saturating the detected signal with light that has not undergone back-scattering in the optical system. The angle-cleave was provided on the distal end of a short piece of graded index multimode fibre spliced on to the input/output SMF SCF. It served as a mode field adapter to expand the mode field diameter (MFD) from the 10 μm MFD of the SMF to match the 24 μm MFD of the NANF HCF, in order to reduce coupling losses between the SMF and the HCF, in order to maximise the amount of optical pulse power launched into the HCF and thereby maximise the signal-to-noise ratio and increase the detectability of the backscattered light. The mode field adapter therefore serves to provide a low loss optical coupling. Where the MFDs are better matched (equal or near-equal) mode field adaption may be omitted, and the angled facet and/or the AR coating provided directly on the OTDR input-output fibre (or some portion of intermediate SCF). The angled facet, the AR coating and the mode field adapter are described in more detail below.

To further ensure a low loss coupling into the HCF, the NANF HCF and the input/output SMF SCF (with the attached angle-polished and AR-coated mode field adapter) were butt-coupled using a pair of alignment stages having a total of five axes of alignment, with a fibre mounted on each. Five-axis alignment allows adjustment in three orthogonal linear directions plus pitch and yaw, and enables better alignment of fibre cores than three-axis (or xyz) alignment, particularly when angled facets are involved.

Two NANF HCF samples were tested, being geometrically similar: NANF 1 had a length of 4.3 km, and a core diameter of 35.4/37.0 μm at its beginning/end (where the beginning or proximal end was coupled to the OTDR device), while NANF 2 had a length of 3.4 km and a core diameter of 35.3/35.8 μm. Additionally, a 1 km of SMF was inserted prior to the NANF sample, to enable visual comparison of the backscattering from SMF and NANF.

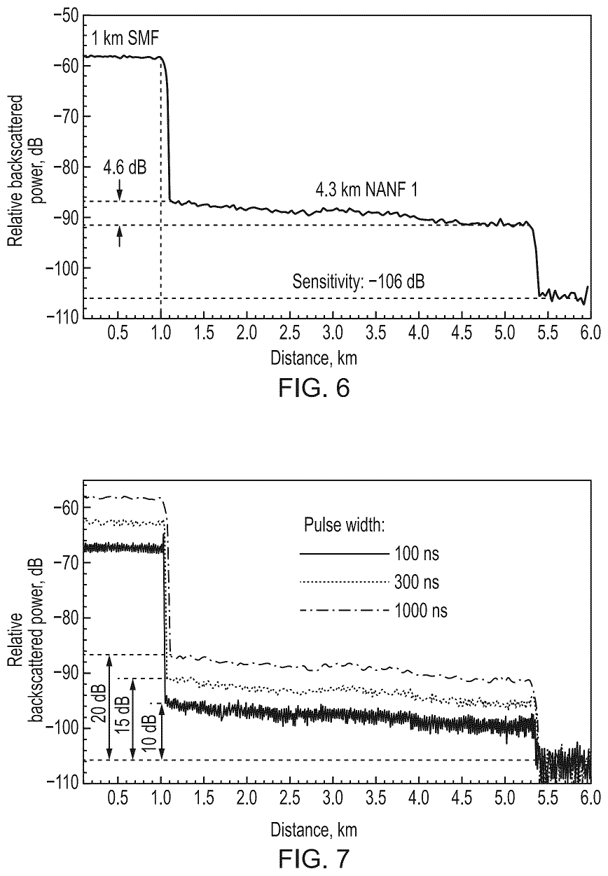

FIG. 6 shows a graph of detected backscattered power measured from sample NANF 1 plus the preceding SMF, resolved over distance along the fibre in the conventional OTDR manner to provide a distributed measurement, using 1 μs pulses. The distance shown on the horizontal axis has been adjusted considering the group refractive indices of a typical SMF (1.46) and NANF (1.003) (this is true also for later Figures). The relative sensitivity (noise level seen at 5.5-6.0 km, i.e. beyond the end of the NANF) was −106 dB; this could be lowered by up to another 4 dB by increasing the time between the pulses sent through the fibre under test (i.e. reducing the pulse repetition rate), but this correspondingly increases the measurement time. Instead, throughout the measurements presented here, the minimum possible time between pulses was used (limited by the pulse round-trip time through the fibre under test). The much higher backscatter detected from the 1 km inserted SMF can be seen at the start of the profile. However, while the backscatter level from the NANF is much lower, it is still appreciably higher than the noise level and therefore usefully detectable, indicating that OTDR on HCFs is achievable. It can be seen that the backscattering signal from the distal end of the NANF 1 sample (remote from the OTDR device) was 4.6 dB lower than at its beginning or proximal end. The attenuation of the NANF can be determined from this, but it is necessary to take account of the slightly larger (by 1.6 μm) core diameter at the distal end of NANF 1, since the backscattering varies with core radius as noted above. Considering the rate of −0.35 dB/um mentioned previously in the discussion of data in FIG. 5, a decrease in the backscattering coefficient by about 0.55 dB is expected in this section of the fibre. This gives a fibre attenuation of (4.6−0.55)/2=2.0 dB, which agrees a transmission loss measurement for NANF 1 of 2.0 dB. Both these measurements provide an average NANF 1 attenuation of 0.47 dB/km.

FIG. 7 shows a further graph of detected backscattered power measured from sample NANF 1 plus the preceding SMF, resolved over distance along the fibre in the conventional OTDR manner to provide a distributed measurement, for different widths of optical pulse launched into the fibre from the OTDR device. As indicated, pulse widths of 100, 300, and 1000 ns (1 μs) were used. The expected decrease in the measured power by 10 dB for 10 times shorter pulses (and hence 10 times less launched optical power) is apparent by comparing the profiles for 100 ns and 1000 ns, while the noise level is unchanged for different pulse lengths. The backscattering from the beginning, proximal end, of the NANF is about 20, 15, and 10 dB above the noise floor respectively for decreasing pulse lengths, which gives an estimated measurement range of up to 20, 15, and 10 km of fibre with 0.5 dB/km attenuation for these three pulse durations. For 1 μs pulses, a maximum dynamic range of 27 dB was predicted as noted above, which is about 7 dB higher than achieved experimentally. However, the predicted value included the 4 dB that can be gained by reducing the pulse repetition rate as discussed above, and does not take in to account a 0.6 dB return loss at the SMF-NANF interface, nor the estimated 1-2 dB return loss at a connectorized interface between the SMF SCF input/output fibre and the OTDR device. Thus, the practically obtained value of 20 dB is in good agreement with the expectations from the device's advertised performance. Considering a state-of-the-art NANF with a loss of 0.22 dB/km, this should allow measurement of 45 km of fibre at 300 m resolution. When measuring from both ends, this would allow the characterisation of up 90 km of fibre. Longer fibre lengths could be expected using an OTDR device with a higher pulse power.

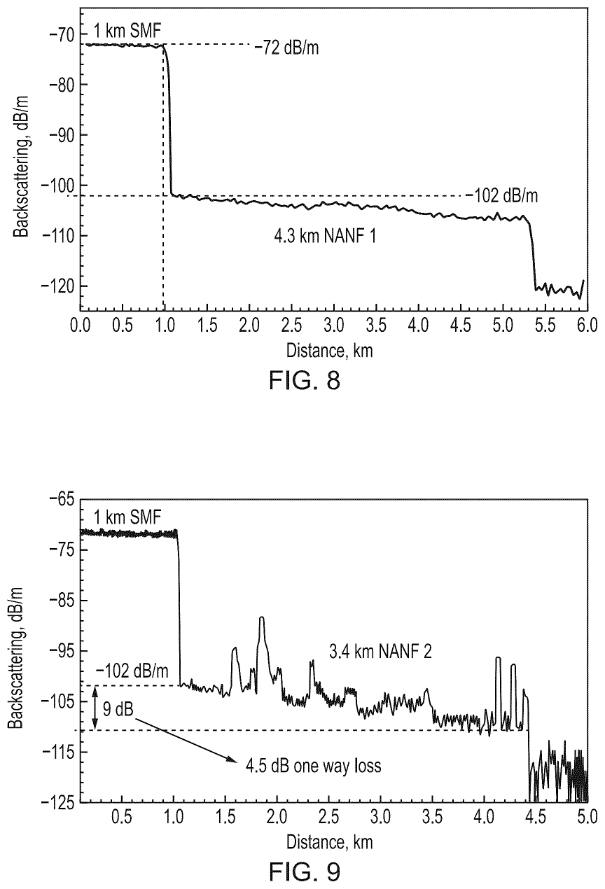

FIG. 8 shows a graph of the data from FIG. 6 converted into a length-normalised backscattering value that takes account of factors including pulse length, insertion losses, and device calibration values. It can been seen that the backscattering from the SMF is at −72 dB/m, compatible with expectations for such a solid core fibre, while for the NANF it is at −102 dB/m, in close agreement with the −100 dB/m expected from simulations.

All measured data obtained with the NANF 1 sample show a small bump between 2.75 km and 2.95 km with an amplitude of about 0.7 dB. Based on the simulations shown in FIG. 5, the rise in the backscattering at that point may be explained by a reduction in the core size by about 2 μm, given the discussed rate of −0.35 dB/um. Given the dependence of backscattering level of HCF core radius as discussed above, it is proposed that OTDR measurements could be used to assess, measure or monitor core size. This could be performed during fibre fabrication, with monitoring carried out during drawing of the fibre for quality control to ensure a consistent core size, with modifications to the draw performed to maintain a constant backscatter level and hence a constant core size, or to achieve a required core size variation. Otherwise, completed fibres could be tested in order that the core size could be measured and characterised.

FIG. 9 shows a graph of backscattered power over distance measured from the NANF 2 sample plus a preceding 1 km of SMF as before, and normalised in the same way as the FIG. 8 graph. The NANF 2 sample which exhibited small manufacturing imperfections along its length. Accordingly, the data was obtained using shorter pulses, of 300 ns duration in order to increase the spatial resolution and allow these defects to be resolved as discrete features in the measurement. The first 400 m of the NANF 2 sample shows similar behaviour to NANF 1, with a backscattering coefficient of −102 dB/m, identical to the value measured for NANF 1. The total round-trip loss was 9 dB (determined from the difference between the values at the ends of the fibre), indicating a 4.5 dB one-way loss. This corresponds to an average NANF 2 loss of 1.3 dB/km, which is in good agreement with the attenuation measured via direct transmission loss. Along the length, several peaks can be identified, all of which produce backscattering levels well below that of SMF, thus representing very small backscattering events.

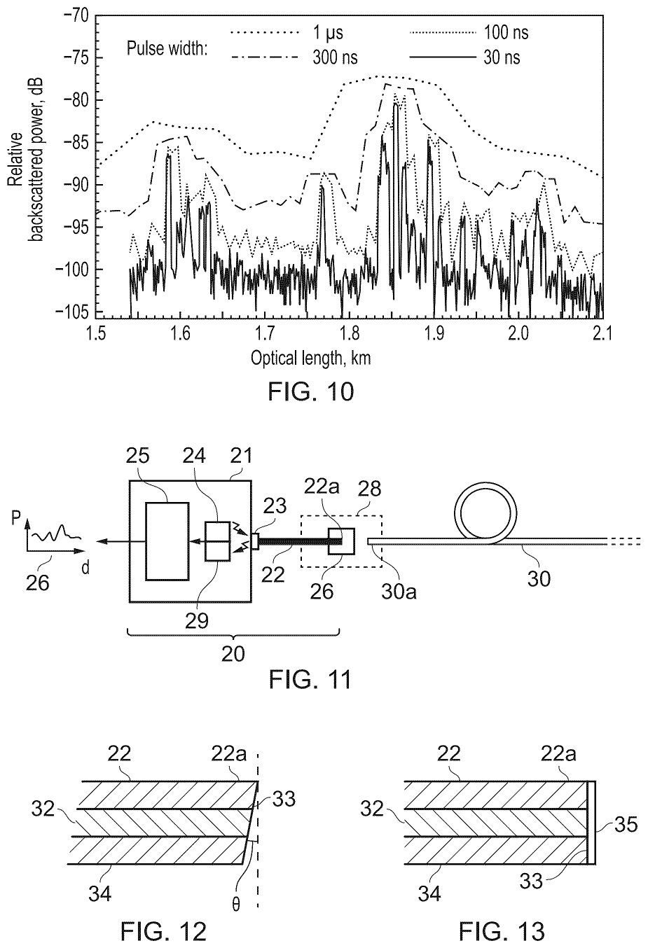

FIG. 10 shows a graph of measured backscattered power over distance obtained from NANF 2 for different pulse lengths. These measurements were obtained in order to further investigate the localized scattering events, by decreasing the pulse duration to increase the spatial resolution. Pulses of 100 ns and 30 ns were used, which are shown together with the 300 ns results from FIG. 9, and also measurements using us pulses. The measurements are restricted to the range of distance along the fibre of 1.5-2.1 km, which has a high concentration of defects as determined from the FIG. 9 data. It can be seen that with 30 ns pulses, scattering features as close as ~10 m apart can be resolved. Note that although with 30 ns pulses the signal is close to the noise floor of the measurement, the scattering peaks rise well above the noise floor, enabling determination of their longitudinal location with an accuracy of ~10 m. Also, the scattering events are visible even under the much lower resolution of 1 us pulses, enabling identification of defects and other scattering sources even from the fastest and highest dynamic range measurement.

The numerous backscattering events presented by the NANF 2 sample all show a backscattering level below that of the SMF. Judging from the backscattering levels at each side of each of these events, it seems that none of them adds significant attenuation. This suggests that any scattering point that adds appreciable attenuation to the fibre, such as a manufacturing defect or damage caused during or after installation would be visible in a measured OTDR trace, confirming that OTDR measurements can be useful for fibre characterization and loss-point identification.

Overall, it is proposed that OTDR could be used for the characterisation of HCFs in the same way as it is used to characterize SMFs and other SCFs, producing continuous (distributed) data on the fibre. Although the experimental results have concentrated on antiresonant HCFs in the form of NANFs, the principles are applicable to other antiresonant HCF designs, and indeed to HCF fibres of all kinds, such as photonic bandgap hollow core fibres. All hollow core fibres can have a gas fill in the hollow core, either present from manufacture or deliberately introduced, and it has been shown that with appropriate treatment of the OTDR apparatus, it is possible to obtain detectable levels of Rayleigh backscatter from gas that can be used in place of backscatter from glass, so that hollow core fibres can be assessed using OTDR comparably with SCFs. Such assessment is not limited to fibre characterisation as discussed thus far. The same technique may alternatively be used for distributed sensing along the fibre length, to detect an external parameter that acts on the fibre and changes the backscatter properties of the gas fill, such as temperature or pressure. Similarly, OTDR may be used specifically for sensing variations in gas pressure or concentration along HCFs. The measurement can be used to resolve the internal gas pressure along the fibre length, which is a useful diagnostic technique for a multitude of sensing applications

The feasibility of using a commercial OTDR device for the characterization and measurement of attenuation in HCFs has thus been proposed and demonstrated, by employing a backscattered signal generated by the air/gas inside the hollow core of the fibre. Given the commercial availability of field-deployable OTDR device used, the proposed measurement approach has the potential to find widespread use, as HCFs start to be increasingly installed commercially. The technique offers a means to leverage the extremely useful length-resolved information of conventional OTDR testing on SCFs for the characterization of HCFs. This provides a post-fabrication tool useful for the testing of cabled and installed fibres, and can enable new and interesting applications of the technique, for example, in distributed gas sensing.

FIG. 11 shows a simplified schematic representation of apparatus for performing OTDR on HCF in accordance with embodiments of the invention. The apparatus comprises an OTDR system or apparatus 20. The OTDR system comprises an OTDR device 21 which has an input/output optical fibre 22 extending from a housing of the device. The input/output fibre 22 may be permanently optically coupled to the housing or may be connectable and disconnectable by a fibre coupler 23 provided on the housing. The optical coupling allows pulses of light generated by an optical source 24 in the housing to be coupled into the input/output fibre 22, and light returning along the input/output fibre 22 via back-propagation, in particular the backscattering of interest from an optical fibre under investigation, which forms a received optical signal, to be delivered from the input/output fibre 22 to an optical detector 29 in the housing. The optical source 24 generates optical pulses at a wavelength λ (which is some cases might be tunable), and with a pulse length which is typically adjustable in order to select a spatial resolution of the OTDR measurements, as discussed above. The wavelength λ may be 1550 nm, which is a standard wavelength for telecommunications so that optical fibres of interest for OTDR are often configured to propagate this wavelength. Other wavelengths might be deliverable however. The optical detector 29 has a high sensitivity in order to detect Rayleigh backscatter, which as explained, in a weak optical effect producing only low power levels from an optical fibre. Importantly, though the detector sensitivity can be designed to be sufficient for the capture of the levels of Rayleigh backscatter created by a solid core optical fibre, and does not need to be of an especially or unusually sensitive design directed to the lower levels of Rayleigh backscatter obtained from the air- or gas-filled core of a hollow core fibre. In other words, the OTDR device may comprise a standard, commercially available, off-the-shelf product which is designed for use with solid core fibres, such as SMF. Custom-built devices may also be used, however. As an example, the optical detector 29 may comprise photon counting photon detectors, which are able to detect or count individual incident photons. The optical detector 29 generates an electrical output signal indicative of the received optical signal in the usual manner, and this is provided to a processor or controller 25 which is configured in the usual way to process and transform the electrical signal into an OTDR output trace or profile 26, showing the detected optical power level P as a function of distance d along the investigated fibre. The profile 26 may provided as a data output, or shown visually on a display on the OTDR device housing, for example. Any display, and also the processor 25 may be included as part of the OTDR device, or may separate elements on the system.

Overall, however, the invention is not concerned in detail with the implementation of the OTDR device, and it can be considered as a “black box”, configured in any known manner for obtaining OTDR measurements from solid core optical fibres.

The input/output fibre 22 has a distal end 22a remote from a proximal end coupled to the OTDR device 21. This distal end 22a is treated or configured in accordance with embodiments of the invention in order to provide low reflection coupling of light pulses out of the input/output fibre 22 and into the proximal end 30a of a hollow core fibre 30 which requires investigation or analysis via OTDR. The treatment of the distal end 22a may comprise various configurations which are discussed further below. Hence in FIG. 11, the treatment applied to the distal end 22a is indicated merely by box 26. Additionally, where necessary, the treatment may also be configured to enable low optical loss coupling between the input/output fibre 22 and the hollow core fibre 30. In order to carry out an OTDR measurement, the input/output fibre 22 and the hollow core fibre 30 are non-permanently aligned with one another to enable maximum or high optical power transmission from the core of one to the core of the other. This may be enabled by an alignment apparatus 28 configured to enable relative spatial adjustment of the fibres ends 22a, 30a so that they can be appropriately positioned relative to one another. This is discussed further below. Alternatively, the input/output fibre 22 and the hollow core fibre 30 may be permanently aligned with one another to enable maximum or high optical power transmission from the core of one to the core of the other, and the hollow core fibre 30 may be optically connected either permanently or non-permanently to a further length of hollow core fibre which it is desired to test. After the OTDR measurement is performed, the hollow core fibre 30 can be uncoupled from the input/output fibre 22, and the OTDR system can be removed and utilised elsewhere.

The input/output fibre 22 is a length or portion of solid core optical fibre, typically singe mode optical fibre although this is not essential. In addition, one or more further lengths of the same or a different type of solid core optical fibre may be spliced or coupled to the distal end of the input/output fibre 22 as it may be provided by a manufacturer together with the OTDR device. This may be done to increase the length of the input/output fibre, for example, or to provide some optical effect. According to the present disclosure, any such additions are considered to be part of the input/output optical fibre 22, and the treatment of the distal end 22a is treatment of the end of any additional portion of fibre added to the input/output fibre. In other words, the treatment relates to the solid core fibre end facet which is coupled with the hollow core fibre, and which provides the glass part of the air/glass boundary between the two fibre types.

FIG. 12 shows a simplified representation of a solid core input/output fibre with a distal end treatment according to a first example, shown as longitudinal cross-section. The input/output fibre 22 comprises a solid glass core 32 surrounded by a solid glass cladding 34 in the known manner. The distal end 22 is treated by having the end facet or face 33 cleaved at an angle, so that the plane of the facet 33 is not perpendicular to the longitudinal axis of the fibre 22. The cleaved facet 33 lies as an angle θ to the perpendicular plane. The angled cleaved facet 33 acts to reduce or remove the 4% back reflection at the glass/air boundary experienced by light leaving the distal end 22a, by directing the reflected light away from the longitudinal axis of the fibre 22 so that it is not able to propagate back to the OTDR detector. The angle θ required to achieve this will depend on the wavelength of the optical pulses and on the refractive index difference between the core 32 and the cladding 34 which supports light guiding by enabling total internal reflection at the core-cladding boundary. The reflected light from the facet 33 is required to be directed backwardly towards the cladding 34 at an angle which will not support total internal reflection. Typically small angles are sufficient, for example in the range of 1°-10°, or 2°-8° or 2°-6° which ranges are considered potentially useful in the current context to suppress or remove back reflections from the input/output fibre distal end facet. Smaller or greater angles might be used as appropriate, however.

FIG. 13 shows a simplified representation of a solid core input/output fibre with a distal end treatment according to a second example, shown as longitudinal cross-section. As before, the input/output fibre 22 comprises a solid glass core 32 surrounded by a solid glass cladding 34 in the known manner. In this example, back reflections from the glass-to-air boundary at the distal end facet 33 of the fibre 22 are reduced by an anti-reflection coating 35 applied over the surface of the end facet 33. Antireflection coatings typically comprise a plurality of optically thin layers arranged in a stack to provide multiple reflective surfaces that set up destructive interference and hence remove power from reflected light. The layers are configured for operation at a particular wavelength, or wavelength range, for example at 1550 nm or 1625 nm which may be used for the optical pulses in an OTDR device intended for testing of telecommunications solid core fibres. The latter wavelength can be feature of OTDR devices to allow testing to be carried out simultaneously with live data transmission in the fibre at the conventional telecommunications wavelength of 1550 nm. In the experiments reported above, a four layer antireflective coating was used [10], but more or fewer layers may be used.

A third example of a distal end treatment for the solid core input/output fibre that can be applied to achieve low reflection operation is an antireflective microstructured/nanostructured surface [11]. The end facet of the fibre, with or without an angled cleave, is processed to create a textured structure comprising randomly distributed surface features or pillars of varying depth and profile, and depth greater than width, and with sub-wavelength dimensions. The features act to suppress the reflection of incident light. Antireflective microstructured surfaces of this type can be referred to as “moth eye” surfaces.

Any of an angled cleave or an antireflection coating or a microstructured surface may be used to provide the input/output fibre with a low or reduced back reflection capability in order to provide a low or reduced reflection interface when coupled to a hollow core fibre. In others examples, combinations of these treatments may be used. An angled end facet may have an antireflection coating applied to it or an antireflective microstructured surface formed on it (not depicted).

The distal end of the input/output fibre may additionally be treated in order to improve the optical coupling from the solid core fibre into the hollow core fibre, thereby providing a low coupling loss. Solid core fibre such as single mode fibre typically provided or used as the input/output fibre of an OTDR device will be configured such that the optical mode field size or diameter of the propagating optical mode it supports matches that of a solid core fibre type likely to be tested with the OTDR device, such as telecommunications optical fibre. Hollow core fibre, on the other hand, typically has a larger mode field diameter; a larger core size is required to propagate a same wavelength, such as 1550 nm. Thus there may be a mismatch in mode field diameter between the input/output fibre and the hollow core fibre, leading of a loss of transmitted optical power when the two are coupled together. To address this, it is proposed to provide a low loss coupling by use of a mode field adapter.

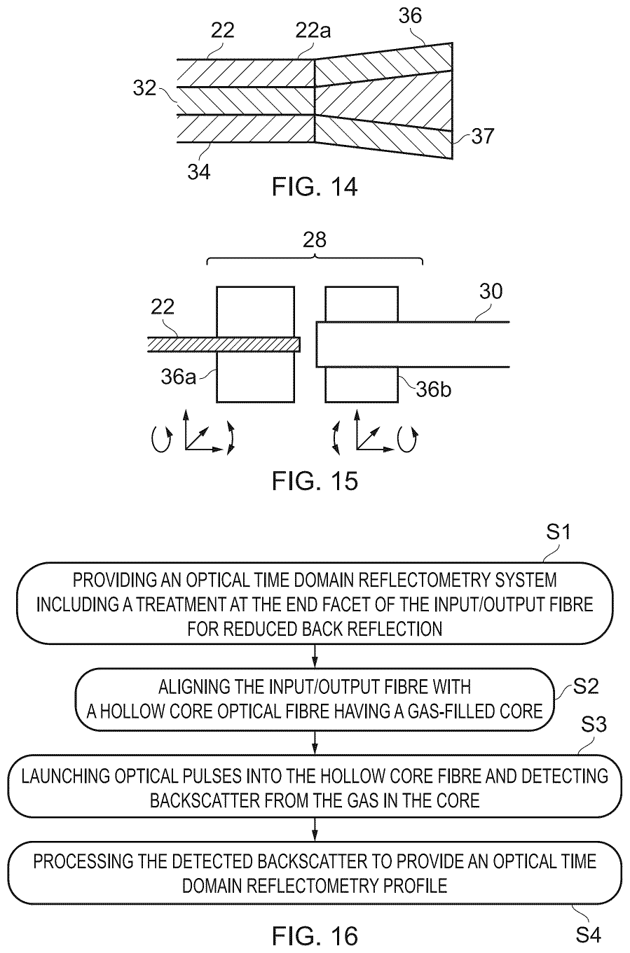

FIG. 14 shows a simplified representation of a solid core input/output fibre with a distal end treatment according to a third example, shown as longitudinal cross-section. As before, the input/output fibre 22 comprises a solid glass core 32 surrounded by a solid glass cladding 34 in the known manner. In this example, the treatment of the distal end 22a of the fibre 22 includes the addition of a mode field adapter 36, which is spliced or otherwise optically joined to the end facet of the fibre 22. The mode field adapter 36 acts to enlarge the mode field diameter of light it receives from the fibre 22 to the mode field diameter of an anticipated optical propagation mode of a hollow core fibre to be tested with the OTDR device. The mode field adapter 36 has a proximal end which is joined to the distal end of the input/output fibre 22 and a distal end where it delivers the enlarged mode field. The end facet 37 at the distal end is coupled to the hollow core fibre to perform OTDR, and defines the glass-to-air interface between solid core and hollow core. Accordingly, the mode field adaptor 36 can be considered a portion of fibre added to the input/output fibre 32 and forming part thereof as described above, so that the low reflection treatment is applied to the end facet 37 of the mode field adapter. In other examples, the mode field adapter 36 may be formed directly from an end part of the input/output fibre 22, rather than comprising a separate portion of fibre. As discussed above the low reflection treatment may comprise either or both of an angled facet and an antireflection coating (neither shown in FIG. 14). The mode field adapter 36 may take any convenient form. FIG. 14 shows it as a short portion of solid core fibre having a tapered core that expands in diameter from the proximal end to the distal end, but other configurations may be used to achieve the mode field enlargement, such as a graded index optical fibre, a graded index optical fibre plus a large mode area solid core fibre, and a solid core fibre with a core enlarged by thermal expansion. Further details of mode field adapters suitable for achieving low loss optical coupling between solid core fibre and hollow core fibre, and hence appropriate for use in the current context may be found in WO 2020/070487 [12].

An aim of the mode field adapter is to implement a low loss optical coupling from the solid core input/output fibre to the hollow core fibre to launch as much of the pulse power into the hollow core fibre as possible, and from the hollow core fibre back to the solid core fibre to preserve as much of the backscattered power as possible for detection by the OTDR device. The low loss coupling may be understood as any arrangement that operates to reduce coupling loss between the fibres compared to the amount of optical power loss that would occur without the low loss coupling. Configurations other than a mode field adapter may be used if preferred. While providing the minimum amount of loss achievable is desirable and useful, some loss at this interface might be tolerated or unavoidable. Accordingly, an aim of the low loss coupling is to transmit or preserve at least 90% or lose at most about 0.5 dB of the power of the optical pulses output from the OTDR device for propagation into the hollow core fibre.

In some cases, however, a mode field adapter or other low loss coupling means may be omitted. For example, it may be that the mode field diameter mismatch is insufficient to cause an intolerable level of power loss across the solid core to hollow core interface. The solid core input/output fibre may be configured as a large mode area fibre specifically intended to match or nearly match the mode field diameter of the hollow core fibre.

FIG. 15 shows a simplified schematic plan view representation of an example of an alignment apparatus for enabling optical alignment between the cores of the solid core and hollow core fibres. In this example, the alignment apparatus 28 comprises a pair of alignment stages which together have five axes of adjustment. A first stage 36a has the distal end of the input/out output fibre 22 mounted on it, and a second stage 36b has the proximal end of the hollow core fibre 30 mounted on it. While the two stages 36a, 36b may be physically separate items, they may alternatively be configured as a single unit, such as held on a common support. In this way, the input/output fibre 22 may be retained mounted on its stage 36a, and the second stage 36b is available as an integral part of the OTDR system, ready for receiving a hollow core fibre 30 for investigation or analysis. An alignment stage or stages with five axes of adjustment provides five degrees of movement. Three of these are orthogonal directions, one parallel with the optical axis of the fibre, corresponding to the longitudinal axis of the end part of the fibre, and two directions in a plane orthogonal to the optical axis. A fourth degree of movement is pitch, allowing the optical axis direction to be tilted about a horizontal axis in the plane orthogonal to the optical axis. A fifth direction is yaw, allowing the fibre to be rotated about a vertical axis in the plane orthogonal to the optical axis. This range and amount of adjustability enables the fibre ends to be aligned for high optical transmission between the cores, aiding the attainment of a low loss coupling between the fibres. This is particularly relevant where the input/output fibre 22 has an angled end facet since this causes optical pulses to be emitted from the fibre 22 at an angle to the optical axis due to refraction at the glass-air interface. The fibre ends may be directly abutted and placed in contact with one another, or may be spaced apart somewhat; again this is relevant for angled end facet where true abutment is more awkward.

Other arrangements for achieving alignment of the fibres ends to maximise optical coupling between the fibres may alternatively be used.

As mentioned above, an OTDR device typically has an adjustable pulse duration in order for the spatial resolution of the OTDR profile to be selected. Longer pulses correspond to a reduced resolution, while shorter pulses give a higher resolution. In the current context, a longer pulse length may be preferred or indeed required, since the power per pulse is higher, giving a correspondingly higher amount of backscattering to be detected and a larger signal to noise ratio. As shown by the experimental results, longer pulses can still give a useful resolution, while shorter pulses can still provide a detectable amount of backscatter, although less distinct from the noise floor. Accordingly, it is proposed that a particularly useful range of pulse durations for OTDR on hollow core fibres is 30 ns to 1000 ns. Shorter or longer pulses are not excluded, however.

The experimental results discussed above show that a hollow core fibre having a length of 45 km and an attenuation of 0.22 dB/km is expected to be able to be usefully analysed with the described OTDR method. By launching pulses into both ends of the hollow core fibre, a total fibre length of 90 km can be observed. However, with lower loss hollow core fibre and with increased pulse power and optimised low reflection and low coupling management a greater backscatter power may be achieved, which can be propagated for further before being attenuated to the noise floor of the system. Accordingly, the method is considered to be applicable to hollow core fibre lengths of up to at least 200 km, or 400 km if investigated from both ends.

FIG. 16 shows a flow chart of steps in an example method for assessing, analysing, testing or measuring a hollow core optical fibre according an aspect of the invention. A first step S1 comprises providing an optical time domain reflectometry system including a treatment at the end facet of the input/output fibre for reduced back reflection, and optionally for reduced coupling loss. This may comprise, for example, providing an optical time domain reflectometry system that comprises an optical source configured to generate optical pulses with wavelength λ, an optical detector configured to detect light at wavelength λ, and an input/output fibre comprising a solid core optical fibre optically coupled at a proximal end to receive optical pulses from the optical source and deliver light to the optical detector, and having at its distal end an end facet with an applied treatment configured to suppress back-reflection of light at wavelength λ caused at an interface of glass forming the core of the solid core optical fibre and air at the end facet.

In a second step S2, the method proceeds to aligning the input/output fibre with a hollow core optical fibre having a gas-filled core, such as by aligning the distal end of the input/output fibre with a proximal end of a hollow core optical fibre having gas present in the hollow core, for optical transmission between the input/output fibre and the hollow core optical fibre.

A third step S3 of the method comprises launching optical pulses into the hollow core fibre and detecting backscatter from the gas in the core. This may be achieved for example by operating the optical source to generate optical pulses for propagation along the input/output fibre and into the hollow core fibre and receiving backscattered light produced by Rayleigh scattering of the optical pulses from the gas in the hollow core of the hollow core fibre and detecting the backscattered light with the optical detector to generate a detected signal.

Finally, the method ends with step S4, comprising processing the detected backscatter to provide an optical time domain reflectometry profile. This may comprise processing the detected signal to create an optical time domain reflectometry profile comprising a distribution of backscattered optical power along a length of the hollow core optical fibre. In other examples, the method may further include steps of using the profile to determine further information about the fibre, such as determining its attenuation, identifying peaks in the profile as arising from defects or damage, or determining information about the core size. The method may be applied to any hollow core optical fibre type, including fibre in a telecommunications network, where the method can assess the fibre during installation or for maintenance after installation, or to fibre during fabrication for monitoring of the fibre characteristics and flaw identification for quality control. The hollow core fibre might be a gas-filled cell for optical sensing, the method comprising analysing a parameter of interest which affects the backscattered optical power and can hence be monitored, measured or identified from the amount of backscatter.

Any gas may be used within the voids of the hollow core fibre, notably within the core, since any gas can produce the required Rayleigh backscatter. The gas may comprise air, including atmospheric air that may enter the core during or after fibre fabrication. Alternatively a specific gas or gas mixture or composition may be introduced to the fibre, such as to provide a hollow core fibre gas cell for sensing purposes. Argon is commonly used as a fill for gas cells, but other gases are not excluded. In summary the hollow core fibre simply has a non-vacuum core.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in the future.

### REFERENCES

[1] G. T. Jasion et al, “Hollow core NANF with 0.28 dB/km attenuation in the C and L bands, paper Th4B.4, 2020 Optical Fiber Communications Conference, March 2020
[2] S. R. Sandoghchi et al, “Optical side scattering radiometry for high resolution, wide dynamic range longitudinal assessment of optical fibres”, Opt. Express, vol. 23, 27960-27974, 2015
[3] U.S. Pat. No. 10,845,268
[4] U.S. Pat. No. 9,904,008
[5] WO 2015/185761
[6] F. Poletti, “Nested antiresonant nodeless hollow core fiber,” Opt. Express, vol. 22, 23807-23828, 2014
[7] H. Sakr et al, “Hollow core NANFs with five nested tubes and record low loss at 850, 1060, 1300 and 1625 nm,” in 2021 Optical Fiber Communications Conference (OFC2021), paper F3A.4, 2021
[8] V. Michaud-Belleau et al, “Backscattering in antiresonant hollow-core fibers: over 40 dB lower than in standard optical fibers,” Optica, vol. 8, no 2, pp. 216-219, February 2021
[9] E. Numkam Fokoua, “Theoretical analysis of backscattering in hollow-core antiresonant fibers,” APL Photonics, vol. 6, 096106, September 2021
[10] D. Suslov et al, “Angled interconnection between standard single-mode fiber and nested nodeless antiresonant fibers”, paper Stu1Q.5, 2021 Conference on Lasers and Electro-Optics, May 2021
[11] U.S. Pat. No. 8,187,481
[12] WO 2020/070487

1. A method of assessing an optical system comprising a hollow core optical fibre, comprising
providing an optical time domain reflectometry system comprising:
an optical source configured to generate optical pulses with wavelength λ;
an optical detector configured to detect light at wavelength λ; and
an input/output fibre comprising a solid core optical fibre optically coupled at a proximal end to receive optical pulses from the optical source and deliver light to the optical detector, and having at its distal end an end facet with an applied treatment configured to suppress back-reflection of light at wavelength λ caused at an interface of glass forming the core of the solid core optical fibre and air at the end facet;
aligning the distal end of the input/output fibre with a proximal end of a hollow core optical fibre having gas present in the hollow core, for optical transmission between the input/output fibre and the hollow core optical fibre;
operating the optical source to generate optical pulses for propagation along the input/output fibre and into the hollow core fibre;
receiving backscattered light produced by Rayleigh scattering of the optical pulses from the gas in the hollow core of the hollow core fibre and detecting the backscattered light with the optical detector to generate a detected signal; and
processing the detected signal to create an optical time domain reflectometry profile comprising a distribution of backscattered optical power along a length of the hollow core optical fibre.

2. A method according to claim 1, wherein the applied treatment at the end facet comprises an angled cleave at the end facet, at an angle to a longitudinal axis of the input/output fibre that directs back-reflected light at the wavelength λ away from a propagating optical mode of the input/output fibre.

3. A method according to claim 1, wherein the applied treatment at the end facet comprises an antireflection coating on the end facet which is configured to reduce reflection of light at the wavelength λ incident on the end facet.

4. A method according to claim 1, wherein the applied treatment at the end facet comprises an antireflective microstructured surface formed on the end facet which is configured to reduce reflection of light at the wavelength λ incident on the end facet.

5. A method according to claim 1, wherein the applied treatment at the end facet is additionally configured to reduce optical transmission loss between the input/output fibre and the hollow core fibre from an amount of optical transmission loss that would occur in the absence of the additional configuration of the applied treatment.

6. A method according to claim 5, wherein the applied treatment at the end facet is configured to reduce optical transmission loss by providing a mode field adapter at the distal end of the input/output fibre that provides the end facet of the input/output fibre, the mode field adapter configured to adapt a mode field diameter of propagating light between a mode field diameter of the input/output fibre and a mode field diameter of the hollow core fibre.

7. A method according to claim 1, wherein the optical pulses have a duration in the range of 30 ns to 1000 ns.

8. A method according to claim 1, wherein the optical detector comprises a photon counting detector.

9. A method according to claim 1, wherein aligning the distal end of the input/output fibre with the proximal end of the hollow core optical fibre comprises supporting each of the distal end and the proximal end on an alignment stage, the alignment stages together having five axes of alignment, and using the alignment stages to adjust the relative positions of the distal end and the proximal end to achieve optical transmission between the input/output fibre and the hollow core optical fibre.

10. A method according to claim 1, wherein the hollow core optical fibre comprises an anti-resonant hollow core optical fibre configured to guide light at the wavelength λ by an anti-resonant effect.

11. A method according to claim 1, wherein the hollow core optical fibre comprises a photonic bandgap hollow core optical fibre configured to guide light at the wavelength λ by a photonic bandgap effect.

12. A method according to claim 1, further comprising determining an attenuation of the hollow core optical fibre from values of backscattered optical power at different length values in the optical time domain reflectometry profile.

13. A method according to claim 1, further comprising finding any peaks of backscattered optical power in the optical time domain reflectometry profile, and identifying length values at which peaks are located as locations of defects or damage in the hollow core optical fibre.

14. A method according to claim 13, wherein the hollow core optical fibre is being installed or is previously installed within a telecommunications network for the transmission of optical data.

15. A method according to claim 1, further comprising extracting information regarding a core size of the hollow core optical fibre from values of backscattered optical power in the optical time domain reflectometry profile.

16. A method according to claim 1, wherein the method is performed during fabrication of the hollow core optical fibre, the fabrication being adjusted in response to the optical time domain reflectometry profile and/or a quality assessment of the hollow core optical fibre being made in response to the optical time domain reflectometry profile.

17. A method according to claim 1, wherein the hollow core optical fibre is configured as a gas cell optical sensor and the method further comprises determining or monitoring a parameter of interest from the optical time domain reflectometry profile.

18. An optical time domain reflectometry system comprising:
an optical source configured to generate optical pulses with wavelength λ;
an optical detector configured to detect light at wavelength λ;
an input/output fibre comprising a solid core optical fibre optically coupled at a proximal end to receive optical pulses from the optical source and deliver light to the optical detector, and having at its distal end an end facet with an applied treatment configured to suppress back-reflection of light at wavelength λ caused at an interface of glass forming the core of the solid core optical fibre and air at the end facet;
an alignment apparatus for aligning the distal end of the input/output fibre with a proximal end of a hollow core optical fibre having gas present in the hollow core, for optical transmission between the input/output fibre and the hollow core optical fibre; and
a processor to receive a detected signal generated by the optical detector from received backscattered light produced by Rayleigh scattering of optical pulses from the optical source in the gas in the hollow core of the hollow core optical fibre, and process the detected signal to create an optical time domain reflectometry profile comprising a distribution of backscattered optical power along a length of the hollow core optical fibre.

19. An optical time domain reflectometry system according to claim 18, wherein the applied treatment at the end facet comprises an angled cleave at the end facet, at an angle to a longitudinal axis of the input/output fibre that directs back-reflected light at the wavelength λ away from a propagating optical mode of the input/output fibre.

20. An optical time domain reflectometry system according to claim 18, wherein the applied treatment at the end facet comprises an antireflection coating on the end facet which is configured to reduce reflection of light at the wavelength λ incident on the end facet.

21. An optical time domain reflectometry system according to claim 18, wherein the applied treatment at the end facet comprises an antireflective microstructured surface formed on the end facet which is configured to reduce reflection of light at the wavelength λ incident on the end facet.

22. An optical time domain reflectometry system according to claim 18, wherein the applied treatment at the end facet is additionally configured to reduce optical transmission loss between the input/output fibre and the hollow core fibre from an amount of optical transmission loss that would occur in the absence of the additional configuration of the applied treatment.

23. An optical time domain reflectometry system according to claim 22, wherein the applied treatment at the end facet is configured to reduce optical transmission loss by providing a mode field adapter at the proximal end of the input/output fibre that provides the end facet of the input/output fibre, the mode field adapter configured to adapt a mode field diameter of propagating light between a mode field diameter of the input/output fibre and a mode field diameter of the hollow core fibre.
